(19) United States
(12) Patent Application Publication
(10) Pub. No.: US 2012/0152899 A1
(43) Pub. Date: Jun. 21, 2012

(54) ALIGNMENT FILM REPAIR APPARATUS AND METHOD THEREOF

(75) Inventors: HSIANG-YIN SHIH, Shenzhen (CN); Chengming He, Shenzhen (CN)

(73) Assignee: Shenzhen China Star Optoelectronics Technology Co. LTD., Shenzhen (CN)

(21) Appl. No.: 13/220,683

(22) Filed: Aug. 30, 2011

(30) Foreign Application Priority Data
Dec. 17, 2010 (CN) 201010597384.1

(51) Int. Cl. C23F 1/00; B32B 43/00

(52) U.S. Cl. 216/67; 156/345.24

(57) ABSTRACT

Disclosed is an alignment film repair apparatus. The alignment film repair apparatus comprises a detection device and a plasma device. The detection device is employed for detecting an edge area of an alignment film to define at least one defect area. The plasma device is employed for generating a plasma reaction to the at least one defect area of the alignment film for removing the at least one defect area. A repair method utilizing the alignment film repair apparatus is also disclosed. With the detection device and the plasma device in cooperation for partially removing the at least one defect area of the alignment film, the issue that removing the whole alignment film with a stripper solvent is the only method according to prior art can be solved.

### BACKGROUND OF THE INVENTION

1. Field of the Invention

The present invention generally relates to an alignment film repair apparatus and method thereof, and more particularly to an alignment film repair apparatus and method thereof applied for LCD panels.

2. Description of Prior Art

An alignment film is to apply liquid crystal polymers to be aligned toward an alignment direction to make the liquid crystal polymers in the LCD own a consistency of direction or to be in a oriental direction. When the electric field drives the liquid crystal polymers, all or a portion of the liquid crystal polymers need consistently synchronous motions for making the display operations quick and consistent.

The alignment film coating skill of new generation is inkjet printing method to cover a TFT substrate or a CF (color filter) substrate with PI (polyimide). Then, a film is formed by diffusion. The biggest process issue of such film formation skill is that the condition of the PI is not good when the PI diffuses at the edge. At the edge, the PI will flow to the positions which are not included in the coating area. Then, the PI liquid drops in fusion cannot form great edge straightness but edge wave. The improvement of the edge wave in prior art is to change the sizes of the liquid drops. Taking DPI (dots per inch) as a measure gauge, the higher the DPI gets, the straighter the edges become. Specifically, the smaller PI liquid drops can be utilized to form the denser arrangement for achieving the higher DPI. However, the real consequence still may change depending on the diffusion conditions of the liquid drops at the edges. The impact factors can be such as the sizes of feeding liquid drops, the condition of the substrate surface, the environment temperature and moisture, etceteras. The final consequence is hardly to be effectively controlled.

Besides, an uneven thickness area may exist at the edges, so called Halo area or edge area because the dry velocities are different at the edges. Once the Halo area is formed in the Active area, the display edges under 25% gray scale have phenomenon of obvious white shift and then the substrates will be judged to be abandoned thereby. Because the aforesaid phenomenon is closely linked to the viscosity of the PI material, the higher the viscosity is, the more the Halo area can be restrained. However, the high viscosity can cause drawbacks of the spraying difficulty of the ink jet sprayer nozzle and the uneven diffusion of the PI liquid drops.

The aforesaid phenomenon can be defected in the alignment film detection apparatus after baking and heating processes. When the alignment film detection apparatus judges the specification of the alignment film not qualified, the substrate will be discharged and performed an overall film stripper procedure thereto. The film stripper procedure is to convey the TFT substrate with the disqualified alignment film or the CF substrate with the disqualified alignment film to the alignment film stripper apparatus. The alignment film stripper apparatus is employed to remove the disqualified alignment film with a stripper solvent. At last, re-inkjet printing the substrate and re-coating an alignment film are performed to the substrate.

Nevertheless, the procedures of removing and re-coating the alignment film take lots of time in the aforementioned method. Meanwhile, more material loss and energy wastage follows and the cost rises.

### SUMMARY OF THE INVENTION

For solving the aforesaid problems in prior, an objective of the present invention is to provide an alignment film repair apparatus with a detection device and a plasma device in cooperation, for partially removing the defect area of the alignment film to solve the aforesaid problems.

Another objective of the present invention is to provide an alignment film repair method employing the alignment film repair apparatus of the present invention to perform a partial repair to the alignment film and improve the repair procedure in prior art.

For solving the aforesaid problems, the present invention utilizes the skill solution described below. The alignment film repair apparatus of the present invention comprises a detection device and a plasma device. The detection device is employed for detecting an edge area of an alignment film to define at least one defect area. The plasma device is employed for generating a plasma reaction to the at least one defect area of the alignment film for removing the at least one defect area. Specifically, the plasma device comprises a reaction gas supply device and a plasma sprayer. The reaction gas supply device is employed for supplying reaction gas. The plasma sprayer is employed for spraying the reaction gas on the at least one defect area of the alignment film.

Furthermore, the plasma sprayer comprises a plasma spray nozzle and a frame. The plasma spray nozzle is employed for spraying the reaction gas. The frame is employed for defining the plasma spray nozzle and limiting a spraying area of the reaction gas sprayed by the plasma spray nozzle. Besides, the spraying area of the reaction gas is set according to the size of the at least one defect area. More specifically, the size of the spraying area is set according to the distance between the plasma sprayer and the alignment film. Preferably, the spraying area is rectangular and the size of the spraying area lies between 0.1 mm² and 100 mm².

In an exemplary embodiment, the plasma device comprises an end point detector for ceasing the plasma reaction.

In an exemplary embodiment, the plasma device is located on the detection device.

For realizing the aforesaid objectives, the present invention further provides an alignment film repair method. The alignment film repair method is employed for repairing an edge area of an alignment film. The method comprises steps below:

(A) employing a detection device to detect an edge area of an alignment film for judging whether a defect area exists or not, if the defect area exists, then defining at least one defect area; and

(B) employing a plasma device to generate a plasma reaction to the at least one defect area of the alignment film for removing the at least one defect area.

In another exemplary embodiment of the present invention, the repair method further comprises a step (C) judging whether the alignment film after repair is qualified or not, if the alignment film is qualified, and then post-baking the alignment film for solidification, if the alignment film is not qualified, and then removing the alignment film with a stripper solvent after step (B).

According to the alignment film repair apparatus of present invention and method thereof, with detection device and the plasma device in cooperation for partially removing the at least one defect area of the alignment film, the issues can be solved that removing the whole alignment film with a stripper solvent is the only method according to prior art and partial repair cannot be realized. Moreover, the plasma device can be located and installed on the detection device. During the detection process, the plasma device can be employed to remove the at least one defect area and improve the repair procedure in prior art.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 shows a diagram of an alignment film repair apparatus performing the repair procedure according to a preferable embodiment of the present invention.

FIG. 2 shows a top view diagram of the alignment film repair shown in FIG. 1.

FIG. 3 shows a sectional diagram of a plasma sprayer shown in FIG. 2 along the AB line.

FIG. 4 shows a flowchart of an alignment film repair method according to a preferable embodiment of the present invention.

### DETAILED DESCRIPTION OF THE INVENTION

Reference will now be made to the drawings to describe the present invention in detail. For a better understanding the objective, characteristics and benefits of the present invention, preferable embodiments are illustrated in accordance with the attached figures for further explanation. The specification of the present invention provides kinds of embodiments to explain the technical characteristics of the different implementations of the present invention. The locations of the respective elements in the embodiments are for clearly explaining the content of the present invention but not limitations thereto. Same grades used for indicating elements in the different embodiments are simplifying the explanation but not mentioning the relevance between the different embodiments.

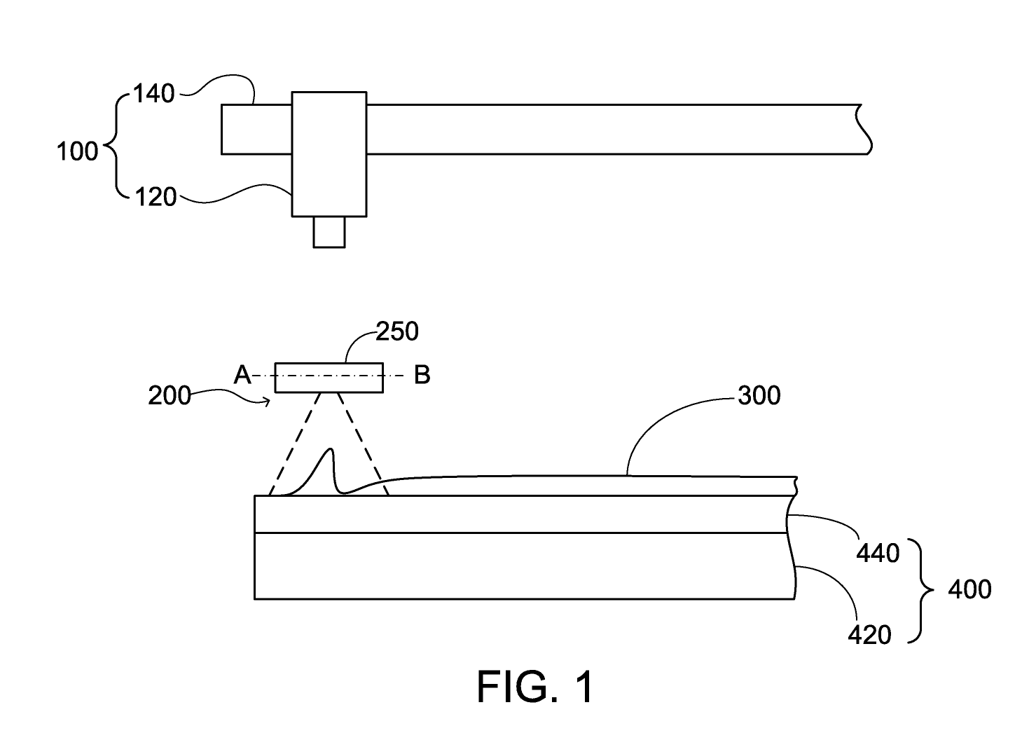

Please refer to FIG. 1, which shows a diagram of an alignment film repair apparatus performing the repair procedure according to a preferable embodiment of the present invention. The alignment film repair apparatus in this preferable embodiment comprises a detection device 100 and a plasma device 200. The liquid of an alignment film 300 becomes liquid drops and covers on a TFT substrate or a CF substrate with inkjet printing method and diffused to form thereon. The liquid of the alignment film 300 is preferably to be PI (polyimide). In this preferable embodiment, the alignment film 300 covers on a TFT substrate 400. The TFT substrate 400 comprises a glass substrate 420 and a TFT layer 440.

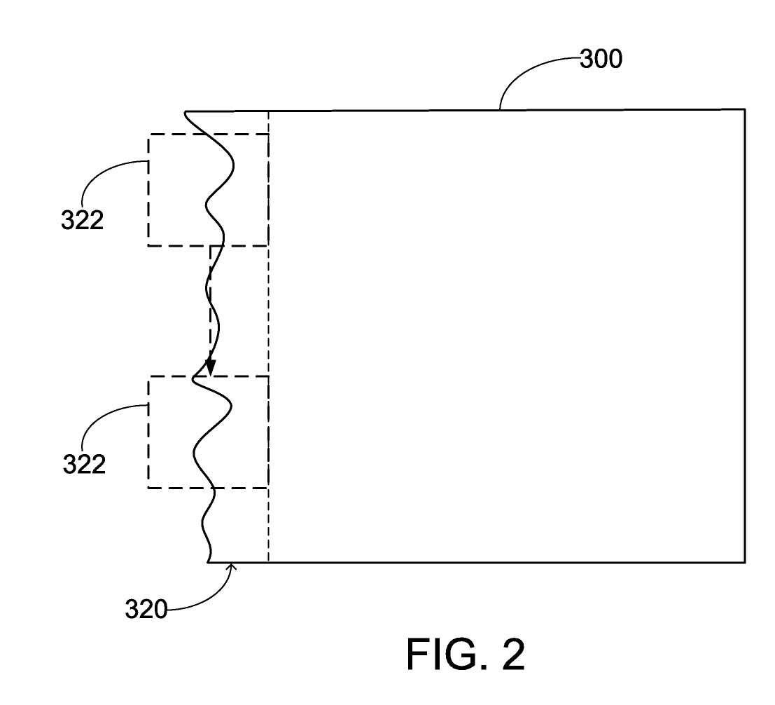

Please refer to FIG. 1 and FIG. 2. FIG. 2 shows a top view diagram of the alignment film repair shown in FIG. 1. The alignment film repair apparatus is employed for repairing edge areas, such as Edge Wave (as shown in FIG. 2), Halo area (as shown in FIG. 1), or both of the alignment film 300.

The detection device 100 is preferably an inspection and comprises an image sensor 120 and an alignment device 140. The image sensor 120 is installed on the alignment device 140 for detecting a defect of the alignment film. In this embodiment, the detection device 100 is employed for detecting edge areas of an alignment film 300 to define at least one defect area 320 (as shown in FIG. 2). The image sensor 120 is preferably to be a CCD image sensor or a CMOS image sensor. The alignment device 140 is preferably to be a cross alignment device to move the image sensor 120 to the required location for performing detection.

The plasma device 200 is employed for generating a plasma reaction to the at least one defect area 320 of the alignment film 300 for removing the at least one defect area 320. Specifically, the plasma device 200 comprises a reaction gas supply device (not shown) and a plasma sprayer 250. The reaction gas supply device is employed for supplying reaction gas. The reaction gas comprises O₂, SF₆, N₂, He, etcetera. The plasma sprayer 250 is employed for spraying the reaction gas on the at least one defect area 320 of the alignment film 300 (as a spraying area 322 shown in FIG. 2) for plasma etching or ashing the at least one defect area 320. The plasma device 200 is preferably located on the detection device 100 for performing the repair right after the detection. Therefore, the plasma sprayer 250 can coordinate the movement of the alignment device 140 for removing the at least one defect area 320 of the alignment film 300. However, the present invention does not restrict the location of the plasma device 200 on the detection device 100. The plasma device 200 also can be independently located from the detection device 100.

Besides, the plasma device 200 further comprises a well known RF power system (not shown) for the persons skilled in the art. By controlling the RF power and composition of the reaction gas, the deposition to the PI material of the alignment film 300 occurs. The chains in the PI polymer are broken by the plasma and some volatile byproduct generate. Though the aforesaid mechanism, the alignment film 300 in the spraying area 322 is removed.

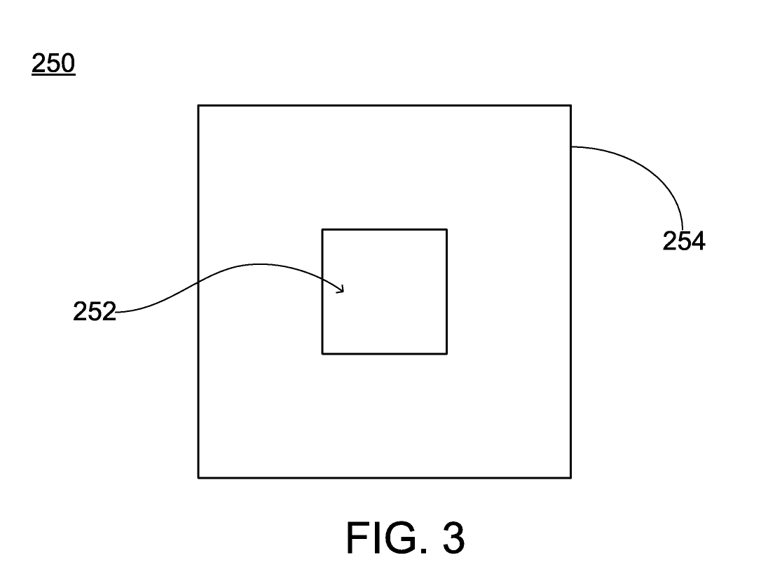

Please refer to FIG. 2 and FIG. 3. FIG. 3 shows a sectional diagram of a plasma sprayer shown in FIG. 2 along the AB line. The plasma sprayer 250 comprises a plasma spray nozzle 252 and a frame 254. The plasma spray nozzle 252 is employed for spraying the reaction gas. The frame 254 is employed for defining the plasma spray nozzle 252 and limiting the spraying area 322 of the reaction gas. In a word, a geometrical figure of the plasma spray nozzle 252 is same as a geometrical figure of the spraying area 322 of the reaction gas. For example, the plasma spray nozzle 252 is rectangular and so is the spraying area 322. However, the present invention does not restrict that the plasma spray nozzle 252 defined by the frame 254 has to be rectangular. It can be any of geometrical figures to achieve the purpose of removing the defect area 320 at the edge.

The spraying area 322 is set according to the size of the defect area 320. More specifically, the size of the spraying area is set according to the distance between the plasma sprayer 250 and the alignment film 300. The closer the distance is, the smaller the spraying area 322 becomes; the farther the distance gets, the larger the spraying area 322 will be. The size of the spraying area preferably lies between 0.1 mm² and 100 mm². Then, a portion of the defect area 320 on alignment film 300 can be repaired but without stripping the whole alignment film 300.

In another embodiment, the plasma device 200 further comprises an EPD (end point detector, not shown) for automatically detecting a concentration of a volatile byproduct for ceasing the plasma reaction. Taking the TFT substrate 400 as an illustration, the ITO layer on the surface of the TFT layer 440 and protection layer at the contact holes (not shown) are exposed after the PI material of the alignment film 300 is removed by plasma etching or ashing. Volatile byproducts different from the byproduct of the PI material may generate. When the end point detector detects that the concentration of the volatile byproduct of the PI changes, the plasma reaction is ceased to protect the TFT layer 440. Similarly, the end point detector can be functioned to protect the ITO layer on the CF substrate, CF (color filter), BM (black matrix), etcetera in a same way.

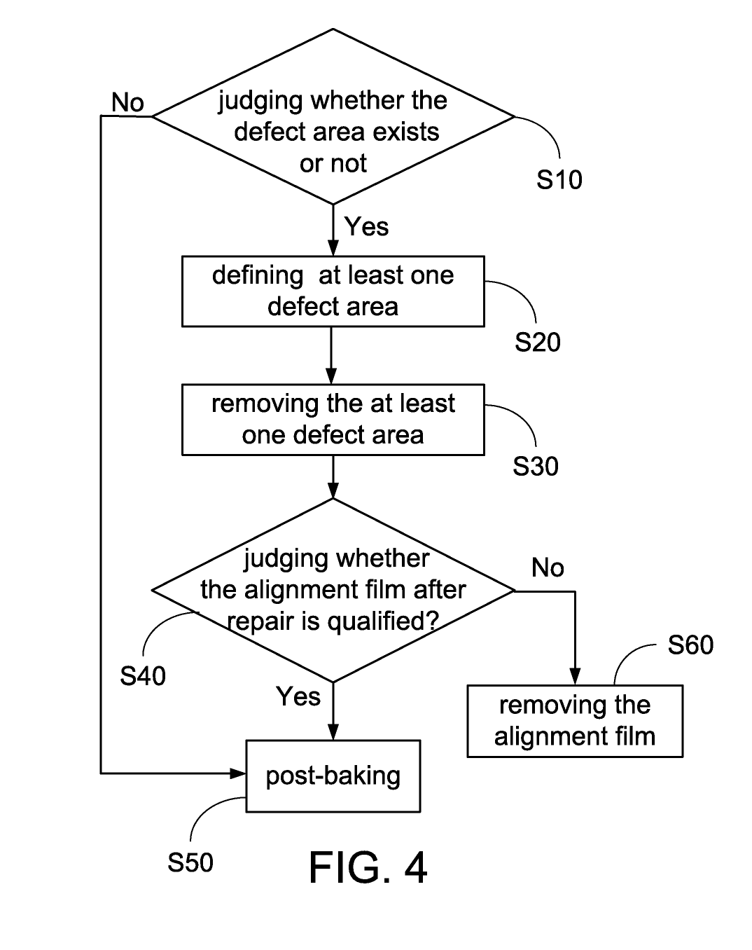

Detail description for a preferable embodiment of the alignment film repair method according to the present invention is introduced here below. In this preferable embodiment, the alignment film repair method utilizes the alignment film repair apparatus in the aforementioned preferable embodiment for implement. Please refer to FIG. 1, FIG. 2 and FIG. 4. FIG. 4 shows a flowchart of an alignment film repair method according to a preferable embodiment of the present invention. The repair method starts from Step S10.

In Step S10, employing the detection device 100 to detect the edge area of the alignment film 300 for judging whether the defect area exists or not, if yes, then proceeding next Step S20, if no, proceeding next predetermined manufacture process, i.e. Step S50. Please notice that this Step is performed after the prebake process of the inkjet printing.

In Step S20, the detection device 100 defines at least one defect area (as shown in FIG. 2), and then proceeds next Step S30.

In Step S30, employing the plasma device 200 to generate the plasma reaction to the at least one defect area 320 of the alignment film 300 for removing the at least one defect area 320 and then, proceeding Step S40. The detail of Step S30 is in the aforementioned and omitted here.

In Step S40, judging whether the alignment film 300 after repair is qualified or not, if yes, then proceeding next predetermined manufacture process, i.e. Step S50; if no, then proceeding Step S60.

In Step S50, post-baking the alignment film 300 for solidification.

In Step S60, removing the alignment film 300 with a stripper solvent for recoating.

According to the alignment film repair apparatus and method thereof, with the detection device 100 and the plasma device 200 in cooperation for partially removing the at least one defect area 320 of the alignment film 300, the issues can be solved that removing the whole alignment film 300 with a stripper solvent is the only method according to prior art and partial repair cannot be realized. Moreover, the plasma device 200 can be located and installed on the detection device 100. During the detection process, the plasma device 200 can be employed to remove the at least one defect area 320. The repair procedure of removing the whole alignment film 300 in prior art can be improved to reduce the cost and time.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An alignment film repair apparatus, comprising:
a detection device, employed for detecting an edge area of an alignment film to define at least one defect area, wherein the detection device comprises an image sensor employed for detecting the alignment film and an alignment device employed for moving the image sensor; and
a plasma device, employed for generating a plasma reaction to the at least one defect area of the alignment film for removing the at least one defect area.

2. The alignment film repair apparatus of claim 1, wherein the plasma device comprises:
a reaction gas supply device, employed for supplying reaction gas; and
a plasma sprayer, employed for spraying the reaction gas on the at least one defect area of the alignment film.

3. The alignment film repair apparatus of claim 2, wherein the plasma sprayer comprises:
a plasma spray nozzle, employed for spraying the reaction gas; and
a frame, employed for limiting a spraying area of the reaction gas sprayed by the plasma spray nozzle.

4. The alignment film repair apparatus of claim 3, wherein the spraying area of the reaction gas is set according to the size of the at least one defect area.

5. The alignment film repair apparatus of claim 3, wherein the size of the spraying area is set according to the distance between the plasma sprayer and the alignment film.

6. The alignment film repair apparatus of claim 2, wherein the size of the spraying area lies between 0.1 mm² and 100 mm².

7. The alignment film repair apparatus of claim 2, wherein the plasma device comprises an end point detector, employed for automatically detecting a concentration of a volatile byproduct for ceasing the plasma reaction.

8. The alignment film repair apparatus of claim 1, wherein the plasma device is located on the detection device.

9. An alignment film repair apparatus, comprising:
a detection device, employed for detecting an edge area of an alignment film to define at least one defect area; and
a plasma device, employed for generating a plasma reaction to the at least one defect area of the alignment film for removing the at least one defect area.

10. The alignment film repair apparatus of claim 9, wherein the plasma device comprises:
a reaction gas supply device, employed for supplying reaction gas; and
a plasma sprayer, employed for spraying the reaction gas on the at least one defect area of the alignment film.

11. The alignment film repair apparatus of claim 10, wherein the plasma sprayer comprises:
a plasma sprayer, employed for spraying the reaction gas; and
a frame, employed for limiting a spraying area of the reaction gas sprayed by the plasma spray nozzle.

12. The alignment film repair apparatus of claim 11, wherein the spraying area of the reaction gas is set according to the size of the at least one defect area.

13. The alignment film repair apparatus of claim 11, wherein the size of the spraying area is set according to the distance between the plasma sprayer and the alignment film.

14. The alignment film repair apparatus of claim 10, wherein the size of the spraying area lies between 0.1 mm² and 100 mm².

15. The alignment film repair apparatus of claim 10, wherein the plasma device comprises an end point detector, employed for automatically detecting a concentration of a volatile byproduct for ceasing the plasma reaction.

16. The alignment film repair apparatus of claim 9, wherein the plasma device is located on the detection device.

17. An alignment film repair method, employed for repairing an edge area of an alignment film, wherein the repair method comprises steps of:
(A) employing a detection device to detect an edge area of an alignment film for judging whether a defect area exists or not, if the defect area exists, then defining at least one defect area; and
(B) employing a plasma device to generate a plasma reaction to the at least one defect area of the alignment film for removing the at least one defect area.

18. The alignment film repair method of claim 17, wherein the repair method further comprises a step of:
(C) judging whether the alignment film after repair is qualified or not, if the alignment film is qualified, and then post-baking the alignment film for solidification, if the alignment film is not qualified, and then removing the alignment film with a stripper solvent after step (B).
